(19) United States
(12) Patent Application Publication
(10) Pub. No.: US 2008/0213501 A1
(43) Pub. Date: Sep. 4, 2008

(54) Method of manufacturing a magnetic recording head

(75) Inventors: Kazuaki Inukai, Kawasaki (JP); Junichi Kon, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/008,070

(22) Filed: Jan. 8, 2008

(30) Foreign Application Priority Data
Feb. 19, 2007 (JP) 2007-37646

(51) Int. Cl. C08J 7/18

(52) U.S. Cl. 427/488

(57) ABSTRACT

A method of manufacturing a magnetic recording head includes a resist pattern forming step of forming a resist layer that is made of thermoplastic resin and in which a hole is formed in the shape of a main magnetic pole of the magnetic recording head, a hardening treatment step of hardening surfaces of the resist layer; a baking step that heat-bakes the resist layer after the hardening treatment step to temporarily make the resist layer fluid; and a main magnetic pole forming step of forming a main magnetic pole by filling the hole in the resist layer with a material of the main magnetic pole.

### BACKGROUND OF THE INVENTION

1. Field of the Invention

The present invention relates to a method of manufacturing a magnetic recording head that forms a main magnetic pole of the magnetic recording head by forming a resist layer that is made of thermoplastic resin and in which a hole in the shape of the main magnetic pole is formed, heat-baking the resist layer to temporarily make the layer fluid, and then filling the hole in the resist layer with the material that composes the main magnetic pole.

2. Related Art

Patent Document 1 discloses a conventional method of manufacturing a magnetic recording head. The steps in the conventional method of manufacturing a magnetic recording head for perpendicular magnetic recording disclosed in Patent Document 1 are schematically shown in FIGS. 5A to 5F. FIGS. 5A to 5F are cross-sectional views of the periphery of a front tip of a main magnetic pole of a magnetic recording head during manufacturing when looking from the air bearing surface side of the magnetic recording head.

FIG. 5A shows a state where an insulating layer 26 has been deposited, an adhesion layer 12 has then been deposited on the surface of the insulating layer 26, and then a volatile metal layer 11 has been deposited. The adhesion layer 12 is provided so that the volatile metal layer 11 tightly adheres to the surface of the insulating layer 26. The adhesion layer 12 is formed of Ti, Ta, Cr, Nb, or the like by sputtering or vapor deposition.

Ru (ruthenium) is used as the material for forming the volatile metal layer 11. The volatile metal layer 11 is formed of ruthenium metal by sputtering or vapor deposition. The volatile metal layer 11 is used as a plating seed layer.

FIG. 5B shows a state where a resist layer 30 has been formed on the surface of the volatile metal layer 11. The surface of the workpiece is coated with resist and the resist is exposed and developed in accordance with a pattern in which the main magnetic pole is to be formed to form a concave 30a with a hole in the shape of the main magnetic pole. The concave 30a is formed so that a part corresponding to the front tip of the main magnetic pole is shaped like an inverted trapezium in cross-section. At the inner bottom surface of the concave 30a, the volatile metal layer 11 made of ruthenium is exposed.

After the resist layer 30 has been formed, the resist is subjected to a hydrophilic treatment. FIG. 5C shows a state where the resist is subjected to an O₂ plasma treatment as the hydrophilic treatment.

When the resist is subjected to the O₂ plasma treatment, the surface of the resist layer 30 changes from hydrophobic to hydrophilic and at the part where the concave 30a is formed, the ruthenium of the volatile metal layer 11 exposed at the bottom surface of the concave 30a is oxidized to become RuO₄. This RuO₄ is vaporized and adheres to inner surfaces 30b of the concave 30a as volatile 11a.

After the hydrophilic treatment has been carried out on the resist layer 30, electroplating is carried out with the volatile metal layer 11 as the plating seed layer to build up a magnetic film (high saturation flux density film) 32 inside the concave 30a. FIG. 5D shows a state where the magnetic film 32 has been formed by plating.

FIG. 5E shows a state where the resist layer 30 has been removed after the magnetic film 32 has been formed. The resist pattern 30 can be removed by chemical dissolution. When the resist pattern 30 is removed, the volatile (RuO₄) that has adhered to the inner surfaces 30b of the concave 30a is removed together with the resist pattern 30.

After the resist pattern 30 has been removed, ion milling is carried out to remove the volatile metal layer 11 and the adhesion layer 12 at positions where the insulating layer 26 is exposed to the surface. FIG. 5F shows a state where unnecessary parts of the volatile metal layer 11 and the adhesion layer 12 have been removed and a main magnetic pole (front tip 10a) composed of the magnetic film 32 has been formed on the insulating layer 26.

Although not disclosed in Patent Document 1, the outer surface of the magnetic film 32 is then trimmed by milling, the entire magnetic film 32 is covered with an alumina layer, and the alumina layer and the upper surface of the magnetic film 32 are ground smooth to complete the main magnetic pole.

In a magnetic recording head for perpendicular magnetic recording, the front tip 10a of the main magnetic pole is shaped in this way like an inverted trapezium in cross-section to prevent so-called “side track erasing”. That is, if the end surface of the front tip 10a of the main magnetic pole that is exposed to the air bearing surface were shaped not like an inverted trapezium but as a rectangle, depending on the skew angle to the track direction on the magnetic disk (magnetic recording medium), there are cases where a side track is erased at a corner of the end surface of the front tip of the main magnetic pole (this phenomenon is called “side track erasing”).

Also, although not disclosed in Patent Document 1, there are cases where a technique of heat-baking the resist is used to make the cross-sectional form of the magnetic film 32 (which becomes the front tip 10a of the main magnetic pole) in the resist pattern 30 described above like an inverted trapezium as shown in FIG. 5F. This process will now be described with reference to FIGS. 6A to 6D.

First, as shown in FIGS. 6A and 6B, a photoresist layer 30 made of a thermoplastic material (thermoplastic resin) is exposed and developed to form a concave 30a cut out in the shape of the main magnetic pole (this corresponds to the process shown in FIG. 5B).

Next, the resist layer 30 is heat-baked by heating the magnetic recording head being manufactured (baking process). By doing so, the resist layer 30 made of the thermoplastic material (thermoplastic resin) becomes fluid, and due to surface tension, the cross-sectional form becomes rounded as shown in FIG. 6C, with the inner surfaces 30b of the concave 30a becoming tapered so as to gradually widen from the bottom toward the opening.

After this, as shown in FIG. 6D, the concave 30a is filled by electroplating with the volatile metal layer 11 as a power feed layer to form the magnetic film 32 that forms the main magnetic pole.

By doing so, it is possible to make the approximate cross-sectional form of the front tip 10a of the main magnetic pole an inverted trapezoid.

### Patent Document 1

Japanese Laid-Open Patent Publication No. 2006-322054 (see FIG. 2 and Paragraphs 0012 to 0019)

### SUMMARY OF THE INVENTION

In the conventional method where the part (i.e., the concave 30a) of the resist layer 30 that corresponds to the front tip of the main magnetic pole is formed like an inverted trapezoid by heat baking the resist layer 30, when the resist layer 30 is heated during the baking process to make the resist layer 30 fluid, the shape of the resist layer 30 also becomes deformed. That is, when the resist layer 30 is made fluid, the corners of the main magnetic pole-shaped hole (i.e., the concave 30a) in the resist layer 30 also deform to become rounded, and as a result, the shape of a main magnetic pole formed by filling the hole will also be deformed.

Accordingly, as shown in FIG. 6D, both side surfaces 10b of the front tip 10a (the magnetic film 32) of the main magnetic pole are not formed straight and instead become rounded. Since a trimming process is carried out on the main magnetic pole as described above, there is the problem that the core width of the front tip 10a of the main magnetic pole and the angle of both side surfaces after trimming become unstable (i.e., fluctuate).

Also, as shown in FIG. 7 (where the main magnetic pole is viewed from above in the laminating direction), a neck portion 10d that is the boundary between the front tip 10a and the yoke portion 10c of the main magnetic pole 10 also deforms to become rounded and there is fluctuation in the neck height of the main magnetic pole (i.e., the length of the front tip 10a, or in other words, the distance from the neck portion 10d to the air bearing surface), resulting in instability in the recording performance.

The present invention was conceived to solve the problem described above and it is an object of the present invention to provide a method of manufacturing a magnetic recording head that can form a main magnetic pole without deformation and therefore can form the main magnetic pole stably without fluctuations in the core width and angles of both side surfaces of the front tip or fluctuations in the neck height of the main magnetic pole.

To achieve the stated object, a method of manufacturing a magnetic recording head according to the present invention includes: a resist pattern forming step of forming a resist layer that is made of a thermoplastic material and in which a hole is formed in the shape of a main magnetic pole of the magnetic recording head; a hardening treatment step of hardening surfaces of the resist layer; a baking step that heat-bakes the resist layer after the hardening treatment step to temporarily make the resist layer fluid; and a main magnetic pole forming step of forming a main magnetic pole by filling the hole in the resist layer with a material of the main magnetic pole.

By doing so, since the surfaces of the resist layer are hardened, only the middle of the resist layer aside from the surfaces becomes fluid during the baking process, so that compared to the conventional method, it becomes difficult for the shape of the corners of the resist layer to deform, so that deformation in the shape of the main magnetic pole can be suppressed. As a result, since it is possible to form both side surfaces of the cross-sectional form of the front tip of the main magnetic pole as linear surfaces, it is possible to stably form the front tip of the main magnetic pole with little fluctuation in the core width and the angles of both side surfaces. Since deformation in the shape of the neck portion is also suppressed, the main magnetic pole can be stably formed with little fluctuation in the neck height.

In addition, the hardening treatment step may harden the surfaces of the resist layer by irradiating the resist layer with plasma.

A gas pressure during plasma irradiation may be in a range of 0.5 to 50 Pascals, inclusive.

Also, a bias power of the plasma may be in a range of 5 to 50 W, inclusive.

By doing so, it is possible to favorably harden the surfaces of the resist layer.

The hardening treatment step may harden the surfaces of the resist layer by irradiating the resist layer with UV rays.

By doing so, the surfaces of the resist layer can be favorably hardened.

According to the method of manufacturing a magnetic recording head according to the present invention, by making it possible to form the main magnetic pole with no deformation, it is possible to form the front tip of the main magnetic pole with little fluctuation in the core width and angles of both side surfaces and to form the main magnetic pole with little fluctuation in the neck height. Accordingly a magnetic recording head with stable recording performance can be manufactured.

### BRIEF DESCRIPTION OF THE DRAWINGS

FIG. 1 is a cross-sectional view showing the construction of a thin-film magnetic head for perpendicular magnetic recording;

FIGS. 2A to 2I are diagrams showing processes when forming a main magnetic pole according to a method of manufacturing a magnetic recording head according to the present invention;

FIGS. 3A to 3H are SEM images of a resist layer and main magnetic pole during manufacturing, where FIGS. 3A to 3D are images during manufacturing according to a conventional method of manufacturing a magnetic recording head and FIGS. 3E to 3H are images during manufacturing according to a method of manufacturing a magnetic recording head according to an embodiment of the invention;

FIGS. 4A to 4D are SEM images of a resist layer where processes up to a baking process have been carried out with different conditions for a plasma irradiation process during a hardening treatment process according to a method of manufacturing a magnetic recording head according to the present invention;

FIGS. 5A to 5F are diagrams useful in explaining a process of forming a main magnetic pole according to a conventional method of manufacturing a magnetic recording head;

FIGS. 6A to 6D are diagrams useful in explaining a process of forming a main magnetic pole according to another conventional method of manufacturing a magnetic recording head (such method including a baking process); and

FIG. 7 is a diagram useful in explaining the form of a main magnetic pole formed by a conventional method of manufacturing a magnetic recording head.

### DESCRIPTION OF THE PREFERRED EMBODIMENTS

Preferred embodiments of a method of manufacturing a magnetic recording head according to the present invention will now be described.

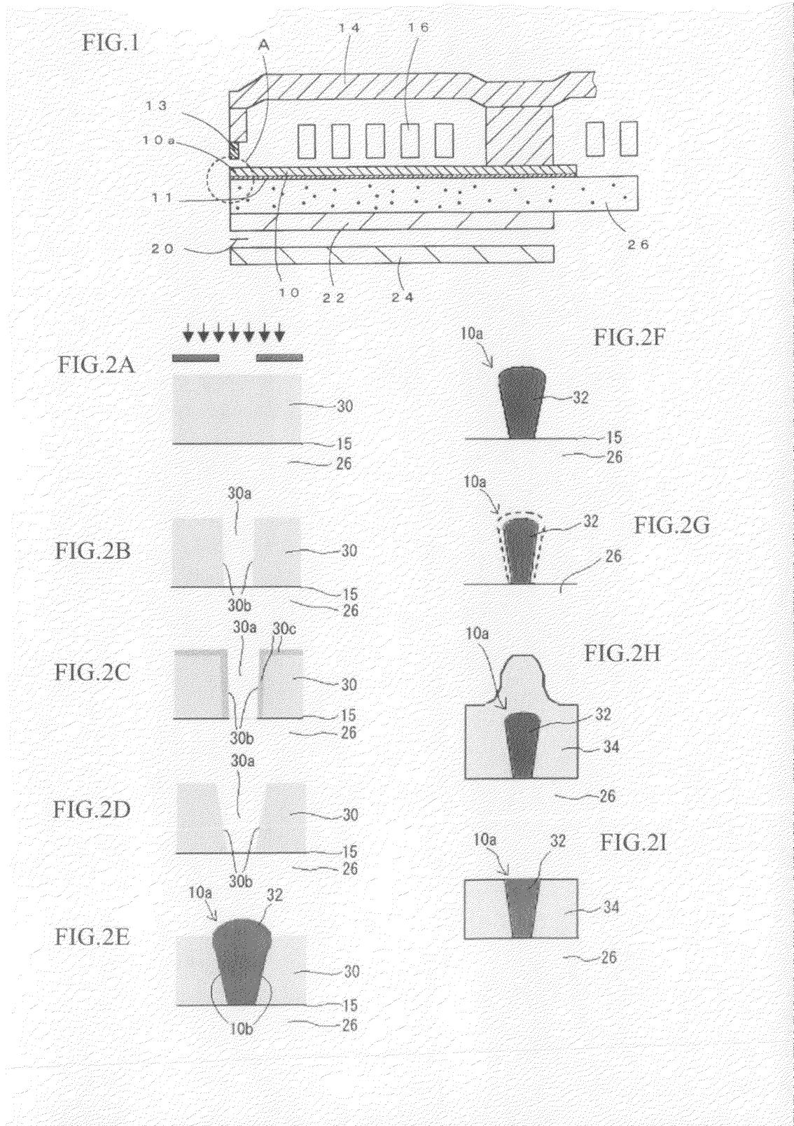

FIG. 1 is a cross-sectional view showing the construction of a thin-film magnetic head for perpendicular magnetic recording.

This thin-film magnetic head includes a main magnetic pole 10, a trailing shield 13, a return yoke 14, and a recording coil 16 as a magnetic recording head and an MR element 20, an upper shield 22, and a lower shield 24 as a magnetic reproduction head.

An insulating layer 26 made of alumina is provided between the upper shield 22 and the main magnetic pole 10. Insulating layers made of alumina or the like are also provided between the main magnetic pole 10 and the recording coil 16, between the recording coil 16 and the return yoke 14, and between the MR element 20 and the upper and lower shields 22, 24.

The thin-film magnetic head is formed by successively laminating films such as the shield layers 22, 24, the MR element 20, the main magnetic pole 10, the recording coil 16, and the return yoke 14 on an Al₂O₃—TiC substrate and patterning the films into predetermined patterns.

In a magnetic recording head for perpendicular magnetic recording, the end surface of the front tip 10a of the main magnetic pole 10 that faces a magnetic medium is formed in an inverted trapezoidal shape so that the magnetic reproduction head side is narrow and the return yoke side is wide.

FIGS. 2A to 2I are diagrams useful in explaining a process that forms the main magnetic pole 10 of the magnetic recording head. In these diagrams, the part marked “A” in FIG. 1 is viewed from the end surface side of the magnetic head.

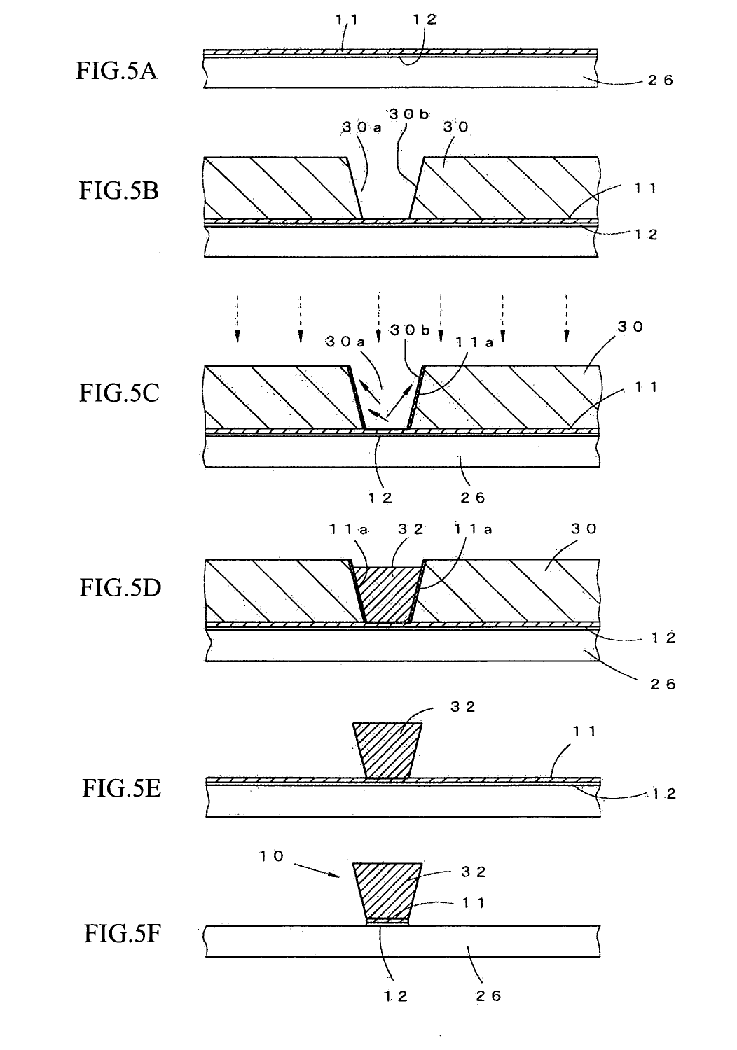

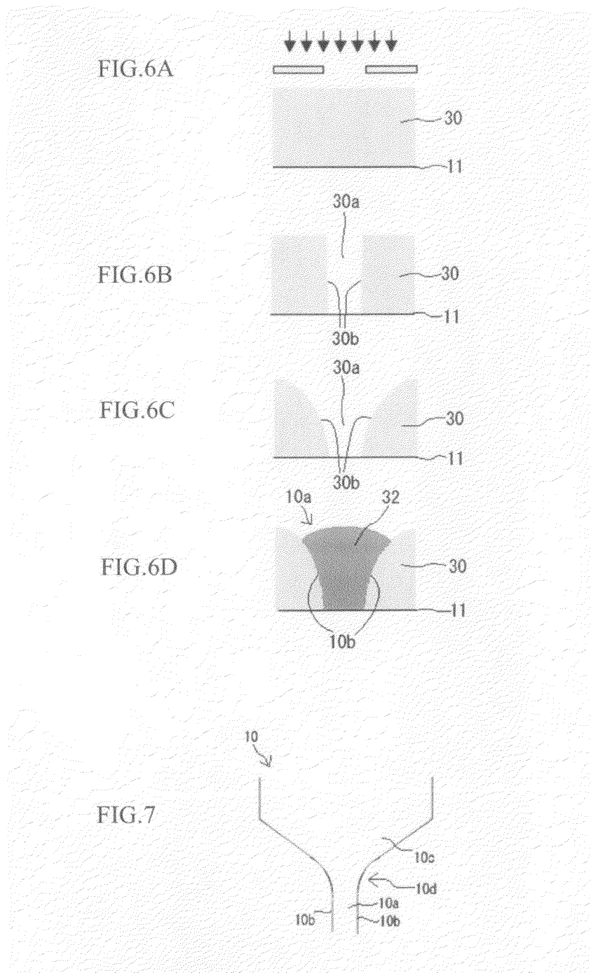

Note that a plating seed layer 15 shown in FIG. 2 corresponds to the volatile metal layer 11 in FIGS. 5A to 5F described in the related art section. Note that for the present invention, the plating seed layer 15 is not necessarily formed of a volatile metal layer. Since the construction and method of manufacturing the layers below the plating seed layer 15 are the same as with the construction of the insulating layer 26 and the adhesion layer 12 shown in FIG. 5A, description thereof is omitted.

### Resist Pattern Forming Process

As shown in FIGS. 2A, 2B, a resist layer 30 made of a thermoplastic resin (i.e., thermoplastic material) is formed on the surface of the plating seed layer 15. More specifically, the surface of the workpiece is coated with a photoresist and the resist is exposed in accordance with a pattern for forming the main magnetic pole and then developed (i.e., photolithography is carried out) to form a concave 30a corresponding to the shape of the main magnetic pole.

### Hardening Treatment

A hardening treatment that hardens the surface of the resist layer 30 is carried out next.

In the hardening treatment of the present embodiment, the resist layer 30 is irradiated with plasma to harden the surfaces 30c of the resist layer 30 (see FIG. 2C).

It is possible to use O₂ or CF₄ as the gas used for plasma irradiation. Alternatively, an inert gas such as N₂, Ar, Ne, or Xe may be used. As examples, the plasma may be generated by capacitive coupling, frequency-excited capacitive coupling, ICP (Inductive Coupled Plasma), ECR (Electron Cyclotron Resonance), RIE, magnetically-excited capacitive coupling, or an arbitrary method.

The gas pressure during plasma irradiation should preferably be in a range of 0.5 to 50 Pascals, the temperature in a range of 18 to 40° C., and the bias power in a range of 5 to 50 W.

By conducting experiments using O₂ plasma, the present inventor confirmed that if the gas pressure and/or bias power exceed the ranges given above, the upper surface of the resist layer 30 in particular will be hardened by oxygen radicals and the inner surfaces 30b of the concave 30a of the resist layer 30 will be difficult to harden compared to the upper surface. On the other hand, the inventor also confirmed that by suppressing the gas pressure and the bias power to the ranges given above, the upper surface of the resist layer 30 and the inner surfaces 30b of the concave 30a can be hardened comparatively uniformly.

Note that during the hardening treatment, any means capable of hardening the surfaces of the resist layer 30 may be used, and the present invention is not especially limited to plasma irradiation.

For example, instead of plasma irradiation, it is possible to harden the surfaces of the resist layer 30 by irradiating the resist layer 30 with UV rays. In this case, the wavelength of the emitted UV rays should preferably be set in a range of 193 to 436 nm.

### Baking Process

After the hardening treatment, a baking process is carried out where the resist layer 30 is heat-baked to make the resist layer 30 temporarily fluid.

In this baking process, the resist layer 30 is heat-baked by heating the magnetic recording head being manufactured. By doing so, the center of the resist layer 30 made of the thermoplastic material (here, thermoplastic resin) becomes fluid, but the surfaces 30c of the resist layer 30 that have been hardened do not become fluid. As a result, as shown in FIG. 2D, the inner surfaces 30b of the concave 30a become tapered so as to gradually widen from the bottom toward the opening of the concave 30a while retaining their form as flat surfaces (i.e., remaining linear in cross-section). That is, the deformation to a rounded form that occurs in the related art can be prevented.

Note that the heating temperature of the resist layer 30 during the baking process will depend on the material of the resist layer 30, but should preferably be set in a range of around 120 to 160° C.

### Main Magnetic Pole Formation Process

Next, the main magnetic pole is formed by filling the concave 30a (i.e., the hole) in the resist layer 30 with the material of the main magnetic pole.

More specifically, electroplating is carried out with the plating seed layer 15 as the power feed layer to build up the magnetic film (high saturation flux density film) 32 inside the concave 30a. FIG. 2E shows the state where the magnetic film 32 has been formed by plating.

Next, the resist layer 30 is removed as shown in FIG. 2F, the plating seed layer 15 is removed to expose the insulating layer 26, and the outer surface of the magnetic film 32 is trimmed by milling as shown in FIG. 2G. The entire magnetic film 32 is then covered with an alumina layer 34 as shown in FIG. 2H, and the alumina layer and upper surface of the magnetic film 32 are ground smooth as shown in FIG. 2I to complete the main magnetic pole.

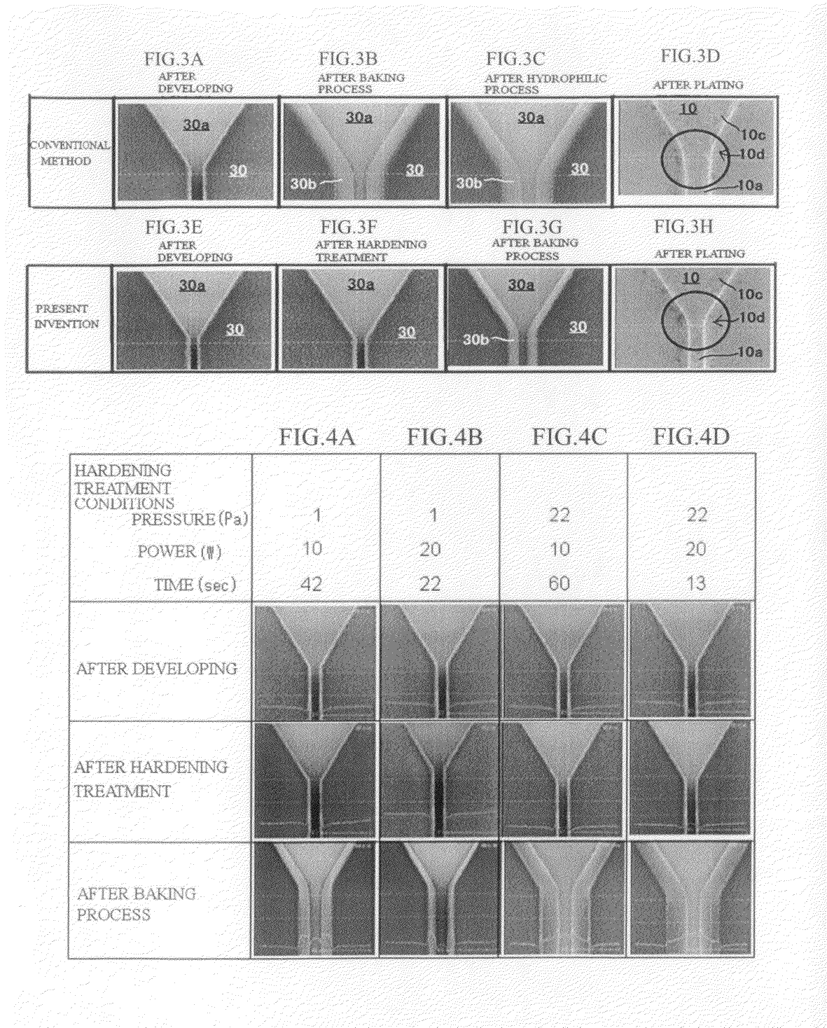

FIGS. 3A to 3H are SEM images where the resist layer 30 and the main magnetic pole 10 during manufacturing are viewed from above in the laminating direction, with FIGS. 3A to 3D being images during manufacturing according to the conventional method of manufacturing a magnetic recording head and FIGS. 3E to 3H being images during manufacturing according to the method of manufacturing according to the present embodiment.

Note that in the examples in FIGS. 3A to 3H, a chemically-amplified resist is used as the resist layer 30.

The baking process was carried out with a heating temperature of 153° C. for 180 seconds.

With the conventional method, as shown in FIG. 3B, it can be seen that the inner surfaces 30b of the concave 30a of the resist layer 30 become rounded due to the baking process. The inner surfaces also become widely opened from the bottom toward the opening, making them even more deformed and rounded.

After this, O₂ plasma irradiation was carried out as the hydrophilic treatment (see FIG. 3C). The O₂ plasma irradiation carried out as the hydrophilic treatment was carried out for twenty seconds with a gas pressure of 100 Pascals, a bias power of 100 W, and a temperature of 25° C.

Next, electroplating is carried out to form the main magnetic pole 10 (see FIG. 3D).

On the other hand, with the method of manufacturing a magnetic recording head according to the present embodiment, the hardening treatment is carried out first (see FIG. 3F), before the baking process is carried out. The O₂ plasma process carried out as this hardening treatment was carried out for 20 seconds with a gas pressure of 20 Pascals, a bias power of 10 W, and a temperature of 25° C. Next, during the baking process, since the surfaces of the resist layer 30 have been hardened, as shown in FIG. 3G and FIG. 2D, the inner surfaces 30b of the concave 30a become tapered so as to gradually widen from the bottom toward the opening while retaining their shape as flat surfaces (i.e., remaining linear in cross-section). That is, it is possible to prevent deformation to a rounded shape that occurs for the conventional art.

After this, the main magnetic pole 10 is formed by electroplating (see FIG. 3H).

It can be seen that the neck portion 10d is less deformed and has a sharper shape in the main magnetic pole 10 formed by the method of manufacturing a magnetic recording head according to the present embodiment (see FIG. 3H) compared to the main magnetic pole 10 formed by the conventional method (see FIG. 3D). That is, with the method of manufacturing a magnetic recording head according to the present embodiment, since the deformation in the shape of the main magnetic pole can be suppressed, the neck height of the main magnetic pole can be stably formed with little fluctuation.

Also, in the same way, the inner surfaces 30b of the concave 30a are formed in a tapered shape so as to gradually widen from the bottom toward the opening while retaining their shape as flat surfaces (i.e., remaining linear in cross-section) (see FIG. 3G and FIG. 2D). Accordingly, deformation of both side surfaces 10b of the front tip 10a of the main magnetic pole 10 (the magnetic film 32) to rounded shapes as in the conventional art can be avoided and both side surfaces 10b of the front tip 10a can be formed as flat surfaces (i.e., so as to be linear in cross-section). This means that when the trimming process described above is carried out, there is little fluctuation in the core width of the front tip 10a and the angles of the side surfaces 10b after the trimming process has been carried out.

Note that Patent Document 1 discloses that an O₂ plasma process is carried out on the resist pattern (see Paragraph 0015 of Patent Document 1). However, since the O₂ plasma process in Patent Document 1 is only carried out as a hydrophilic treatment for the plating, it is carried out immediately before the plating process for the main magnetic pole (see Paragraph 0017 of Patent Document 1) in a state where a part of the resist layer for forming the main magnetic pole has been formed as an inverted trapezoid in cross-section (see Paragraph 0014 of Patent Document 1). That is, in conventional methods, the O₂ plasma process is carried out immediately before the plating process for the main magnetic pole in a state where the cross-sectional form of the part of the resist layer that corresponds to the front tip of the main magnetic pole has already been formed as an inverted trapezoid (i.e., the O₂ plasma process is carried out after the baking process).

On the other hand, the present invention carries out the hardening treatment, such as an O₂ plasma process, with the object of hardening the surfaces of the resist layer before the baking process where the resist layer is shaped into an inverted trapezoid. Due to this difference in objects, the order of processes and irradiation conditions for the plasma differ to the related art.

More specifically, a plasma process carried out as a hydrophilic treatment should preferably be carried out with a gas pressure of at least 50 Pascals and the plasma processing time only needs to be long enough to remove residue that remains in the pattern after developing before plating is carried out.

On the other hand, a plasma process carried out to harden the surface is carried out at a low pressure of 0.5 to 50 Pascals and the plasma processing time is determined by the extent of hardening and the inverted trapezoidal shape after the baking process. By carrying out the process at a low pressure, it is possible to harden the surfaces right down to the base of a resist pattern with a narrow core width, so that the linear shapes can be retained even after baking.

### SPECIFIC EXAMPLES

FIGS. 4A to 4D are SEM images of a resist layer for which processes as far as the baking process have been carried out with different plasma irradiation conditions during the hardening treatment.

FIG. 4A shows the case where the O₂ gas pressure was set at 1 Pascal, the bias power at 10 W, and the plasma irradiation time at 42 seconds. In the same way, FIG. 4B shows the case where the O₂ gas pressure was set at 1 Pascal, the bias power at 20 W, and the plasma irradiation time at 22 seconds. FIG. 4C shows the case where the O₂ gas pressure was set at 22 Pascals, the bias power at 10 W, and the plasma irradiation time at 60 seconds. FIG. 4D shows the case where the O₂ gas pressure was set at 22 Pascals, the bias power at 20 W, and the plasma irradiation time at 13 seconds.

Note that in each case, the heating temperature during the baking process was set at 157° C. and the processing temperature was set at 180 seconds.

Also in each case, a chemically-amplified positive resist was used as the resist layer.

As can be seen from FIGS. 4A to 4D, with a method of manufacturing a magnetic recording head according to the present invention, the inner surfaces of the concaves are tapered so as to gradually widen from the bottom toward the opening while retaining their shapes as flat surfaces (i.e., so as to be linear in cross-section) and are hardly rounded.

Also, as can be understood by comparing FIGS. 4A to 4D, the higher the gas pressure and bias power during the plasma process, the larger the change in the angle of inclination of the inner surfaces. These conditions should be appropriately set in accordance with the desired shape for the main magnetic pole.

What is claimed is:

1. A method of manufacturing a magnetic recording head, comprising:
a resist pattern forming step of forming a resist layer that is made of a thermoplastic material and in which a hole is formed in the shape of a main magnetic pole of the magnetic recording head;
a hardening treatment step of hardening surfaces of the resist layer;
a baking step that heat-bakes the resist layer after the hardening treatment step to temporarily make the resist layer fluid; and
a main magnetic pole forming step of forming a main magnetic pole by filling the hole in the resist layer with a material of the main magnetic pole.

2. A method of manufacturing a magnetic recording head according to claim 1, wherein the hardening treatment step hardens the surfaces of the resist layer by irradiating the resist layer with plasma.

3. A method of manufacturing a magnetic recording head according to claim 2, wherein a gas pressure during plasma irradiation is in a range of 0.5 to 50 Pascals, inclusive.

4. A method of manufacturing a magnetic recording head according to claim 2, wherein a bias power of the plasma is in a range of 5 to 50 W, inclusive.

5. A method of manufacturing a magnetic recording head according to claim 3, wherein a bias power of the plasma is in a range of 5 to 50 W, inclusive.

6. A method of manufacturing a magnetic recording head according to claim 1, wherein the hardening treatment step hardens the surfaces of the resist layer by irradiating the resist layer with UV rays.
